(19) United States
(12) Patent Application Publication
(10) Pub. No.: US 2005/0275823 A1
(43) Pub. Date: Dec. 15, 2005

(54) PHOTOSENSITIVE MEDIA CASSETTE FOR AN IMAGING DEVICE

(76) Inventors: Alphonse D. Camp, Rochester, NY (US); Mark E. Brooks, Webster, NY (US); Brad J. Fish, Hilton, NY (US); Theodore K. Ricks, Rochester, NY (US)

Correspondence Address: Mark G. Bocchetti;Patent Legal Staff, Eastman Kodak Company, 343 State Street, Rochester, NY, 14650-2201, US

(21) Appl. No.: 10/866,479

(22) Filed: Jun. 11, 2004

(51) Int. Cl. G03B 27/00

(52) U.S. Cl. 355/400

(57) ABSTRACT

A cassette arrangement includes a light-tight, moisture proof pouch that is adapted to hold a stack of photosensitive sheets such as microencapsulated media and load the sheets into an image-forming device in a light tight manner.

### FIELD OF THE INVENTION

The present invention relates to a photosensitive media cassette for an imaging device, and more particularly a re-loadable media cassette that includes a light-tight moisture proof pouch for holding microencapsulated media.

### BACKGROUND OF THE INVENTION

Image forming devices are known in which media having a layer of microcapsules containing a chromogenic material and a photohardenable or photosoftenable composition, and a developer, which may be in the same or a separate layer from the microcapsules, is image-wise exposed. In these devices, the microcapsules are ruptured, and an image is produced by the differential reaction of the chromogenic material and the developer. More specifically, in these image-forming devices, after exposure and rupture of the microcapsules, the ruptured microcapsules release a color-forming agent, whereupon the developer material reacts with the color-forming agent to form an image. The image formed can be viewed through a transparent support or a protective overcoat against a reflective white support as is taught in, for example, U.S. Pat. No. 5,783,353 and U.S. Publication No. 2002/0045121 A1. Typically, the microcapsules will include three sets of microcapsules sensitive respectively to red, green and blue light and containing cyan, magenta and yellow color formers, respectively, as taught in U.S. Pat. No. 4,772,541. Preferably a direct digital transmission imaging technique is employed using a modulated LED print head to expose the microcapsules.

Conventional arrangements for developing the image formed by exposure in these image-forming devices include using spring-loaded balls, micro wheels, micro rollers or rolling pins, and heat from a heat source is applied after this development step to accelerate development.

The photohardenable composition in at least one and possibly all three sets of microcapsules can be sensitized by a photo-initiator such as a cationic dye-borate complex as described in, for example, U.S. Pat. Nos. 4,772,541; 4,772,530; 4,800,149; 4,842,980; 4,865,942; 5,057,393; 5,100,755 and 5,783,353.

The above describes micro-encapsulation technology that combines micro-encapsulation with photo polymerization into a photographic coating to produce a continuous tone, digital imaging member. With regard to the media used in this technology, a substrate is coated with millions of light sensitive microcapsules, which contain either cyan, magenta or yellow image forming dyes (in leuco form). The media further comprises a monomer and the appropriate cyan, magenta or yellow photo initiator that absorb red, green or blue light respectively. Exposure to light, after the induction period is reached, induces polymerization.

When exposure is made, the photo-initiator absorbs light and initiates a polymerization reaction, converting the internal fluid (monomer) into polymer, which binds or traps leuco dye from escaping when pressure is applied.

With no exposure, microcapsules remain soft and are easily broken, permitting all of the contained dye to be expelled into a developer containing binder and developed which produces the maximum color available. With increasing exposure, an analog or continuous tone response occurs until the microcapsules are completely hardened, to thereby prevent any dye from escaping when pressure is applied.

Conventionally, as describe above, in order to develop the image, pressure is applied across the image. As a final fixing step, heat is applied to accelerate color development and to extract all un-reacted liquid from the microcapsules. This heating step also serves to assist in the development of available leuco dye for improved image stability. Generally, pressure ruptured capsules (unhardened) expel lueco dye into the developer matrix.

In supplying media to the image-forming device as described above a cassette that holds the media can be used. A drawback with certain cassettes is that they do not provide for a reliable enclosure that (1) enables a consistent loading of media into the image-forming device without damaging the media; and (2) provides an adequate light-tight and moisture proof environment.

Therefore, a need exists to provide a light-tight, low cost pouch with predictible tear characteristics to enable the loading of a light sensitive recording media in room or outdoor lighting conditions into a reusable media cassette without damage to the media. There is also a need to provide for a pouch as noted above which is inexpensive, maintains the quality of the media and is easy to use.

### SUMMARY OF THE INVENTION

The present invention therefore provides for a cassette arrangement having a light-tight pouch which addresses the drawbacks noted above, as well as an image-forming device which is adapted to interface with the light-tight pouch in accordance with the present invention.

The present invention therefore provides for a cassette arrangement for photosensitive media which comprises a housing having a holding area and a door which is movable between an open position and a closed position, with the door having a protruding member on one end of the door and the housing having an interface end which is adapted to interface with an imaging device when the cassette arrangement is inserted in the imaging device; and a light tight pouch which is adapted to hold a stack of photosensitive media therein, with the light-tight pouch having a surface portion on a first end and a sealed tab on a second end, with the sealed tab including a score line to enable a controlled tearing of the sealed tab and an opening of the pouch. The holding area is adapted to receive the light tight pouch therein, such that when the door is in the closed position, the protruding member of the door presses against the surface portion of the pouch and the sealed tab of the pouch protrudes through the interface end of the housing to permit a tearing of the tab along the score line and an opening of the pouch when the pouch is located in the holding area and the door is in the closed position.

The present invention further relates to an image forming device which comprises an imaging member adapted to form a latent image on photosensitive media; a development member for developing the latent image; and a cassette arrangement adapted to hold a stack of photosensitive media therein and interface with the image forming device to transfer the media from the cassette arrangement to the image forming device. The cassette arrangement comprises a housing having a holding area and a door which is movable between an open position and a closed position, with the door having a protruding member on one end of the door and the housing having an interface end which is adapted to interface with an imaging device when the cassette arrangement is inserted in the imaging device; and a light tight pouch which is adapted to hold a stack of photosensitive media therein, with the light-tight pouch having a surface portion on a first end and a sealed tab on a second end, and the sealed tab including a score line to enable a controlled tearing of the sealed tab and an opening of the pouch. The holding area is adapted to receive the light tight pouch therein, such that when the door is in the closed position, the protruding member of the door presses against the surface portion of the pouch and the sealed tab of the pouch protrudes through the interface end of the housing to permit a tearing of the tab along the score line and an opening of the pouch when the pouch is located in the holding area and the door is in the closed position.

The present invention further provides for a method of processing photosensitive media which comprises the steps of using a light-tight pouch to store a stack of photosensitive media, with the light-tight pouch having a surface portion at a first end and a sealed tab at a second end, and a tear line being provided in a vicinity of the sealed tab; placing the pouch into a cassette arrangement having a door with a holding member and a slidable portion, such that a closing of the door causes the holding member of the door to press against the surface portion of the pouch and locates the sealed tab in a manner in which the sealed tab extends through an interface end of the cassette arrangement; pulling the tab to cause a tearing of the pouch along the tear line and an opening of the pouch while the pouch is in the cassette arrangement; inserting the cassette arrangement into an image forming device in a manner in which the slidable portion is opened to provide an access location for a topmost sheet of the stack of media; using a pick roller to contact the topmost sheet of media through the access location and convey the media into the image forming device; and processing the media in the image forming device.

The present invention further relates to a cassette arrangement for photosensitive media which comprises a housing having a holding area and a door, with the door having a protruding member on one end and said housing having an interface end which is adapted to interface with an image forming device when the cassette arrangement is inserted in the imaging device; and a pouch which is adapted to hold photosensitive media therein, with the pouch having a surface portion and a sealed tab, and the sealed tab including a score line to enable a controlled tearing of the sealed tab and an opening of the pouch. The holding area is adapted to receive the pouch therein such that when the door is closed, the protruding member of the door presses against the surface portion of the pouch and the sealed tab of the pouch protrudes through the interface end of the housing to permit a tearing of the tab along the score line and an opening of the pouch when the pouch is located in the holding area and the door is closed.

### BRIEF DESCRIPTION OF THE DRAWINGS

FIG. 1A schematically shows an image-forming device;

FIG. 1B schematically shows an example of a pressure applying system for the image-forming device of FIG. 1A;

FIGS. 2A and 2B illustrate a media cassette arrangement including a pouch adapted to interface with an image-forming device in accordance with the present invention;

FIG. 3 is a front view of the cassette arrangement of FIG. 2;

FIG. 4 is a further front view of the cassette arrangement of FIG. 2; and

FIG. 5 is a further view of the cassette arrangement of FIGS. 3 and 4, with a sheet of media being in the process of coming out of the cassette arrangement.

### DETAILED DESCRIPTION OF THE INVENTION

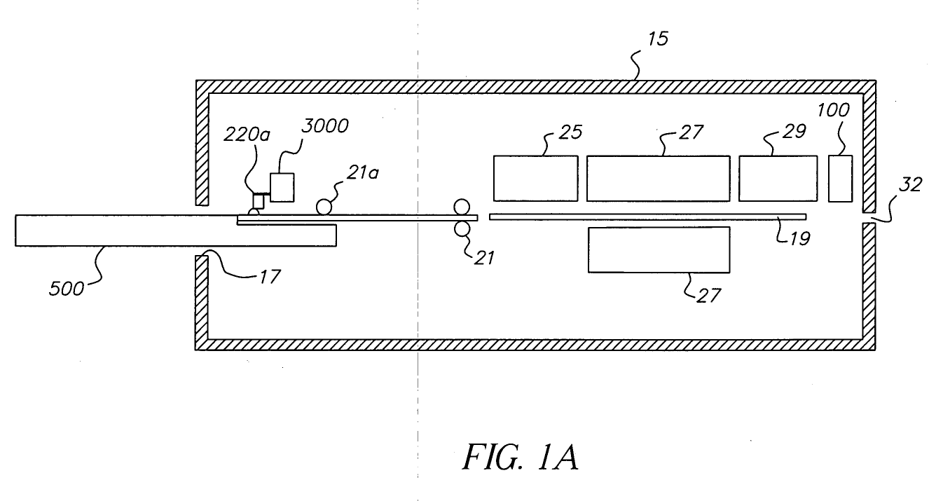

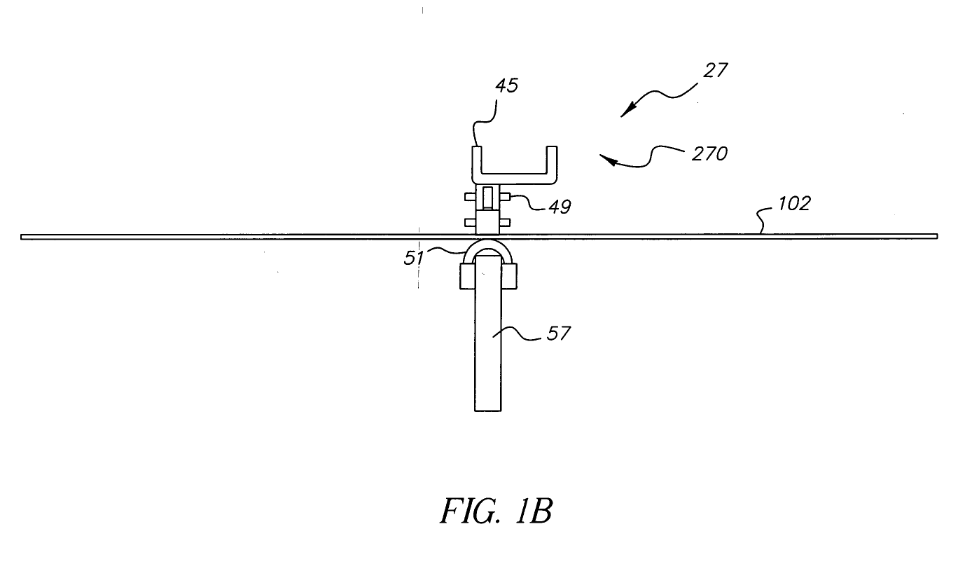

Referring now to the drawings, wherein like reference numerals represent identical or corresponding parts throughout the several views, FIG. 1A is a schematic view of an image-forming device 15 pertinent to the present invention. Image forming device 15 could be, for example, a printer that includes an opening 17 that is adapted to receive a cartridge, cassette or cassette arrangement 500 containing photosensitive media. As described in U.S. Pat. No. 5,884,114, the cassette arrangement could be a light-tight cartridge in which photosensitive sheets are piled one on top of each other. When inserted into image forming device 15, a feed mechanism that includes, for example, a feed or pick roller 21a in image forming device 15, working in combination with a cooperating mechanism or member 3000 in the cassette arrangement, cooperate with each other to open the cassette arrangement and pull one sheet at a time from the cassette arrangement into image forming device 15.

Once inside image forming device 15, photosensitive media travels along media path 19, and is transported by, for example, drive rollers 21 connected to, for example, a driving mechanism such as a motor. The photosensitive media will pass by an imaging member 25 in the form of an imaging head that could include a plurality of light emitting elements (LEDs) that are effective to expose a latent image on the photosensitive media based on image information. After the latent image is formed, the photosensitive media is conveyed past a processing assembly or a development member 27. Processing assembly 27 could be a pressure applicator, pressure assembly or pressure development apparatus, wherein an image such as a color image is formed based on the image information by applying pressure to microcapsules having imaging material encapsulated therein to crush the microcapsules. The pressure could be applied by way of spring-loaded balls, micro wheels, micro rollers, rolling pins, etc.

FIG. 1B schematically illustrates an example of a pressure applicator 270 for pressure development apparatus 27. In the example of FIG. 1B, pressure applicator 270 is a crushing roller arrangement that provides a point contact on photosensitive medium 102. More specifically, pressure applicator 270 includes a support 45 that extends along a width-wise direction of photosensitive medium 102. Moveably mounted on support 45 is a crushing roller arrangement 49 that is adapted to move along the length of support 45, i.e., across the width of photosensitive medium 102. Crushing roller arrangement 49 is adapted to contact one side of photosensitive medium 102. A backing member in the form of a beam or roller type member 51 is positioned on an opposite side of photosensitive medium 102 and can be provided on a support or spring member 57. Beam or roller type member 51 is positioned so as to contact the opposite side of photosensitive medium 102 and is located opposite crushing roller arrangement 49. Beam or roller type member 51 and crushing roller arrangement 49 when in contact with photosensitive medium 102 on opposite sides provide a point contact on photosensitive medium 102. Crushing roller arrangement 49 is adapted to move along a width-wise direction of photosensitive material 102 so as to crush microcapsules and release coloring material. Further examples of pressure applicators or crushing members are described in U.S. Pat. Nos. 6,483,575 and 6,229,558.

Within the context of the present invention, the imaging material comprises a coloring material (which is used to form images) or material for black and white media. After the formation of the image, the photosensitive media is conveyed past heater 29 (FIG. 1A) for fixing the image on the media. In a through-feed unit, the photosensitive media could thereafter be withdrawn through an exit 32. As a further option, image-forming device 15 can be a return unit in which the photosensitive media is conveyed or returned back to opening 17.

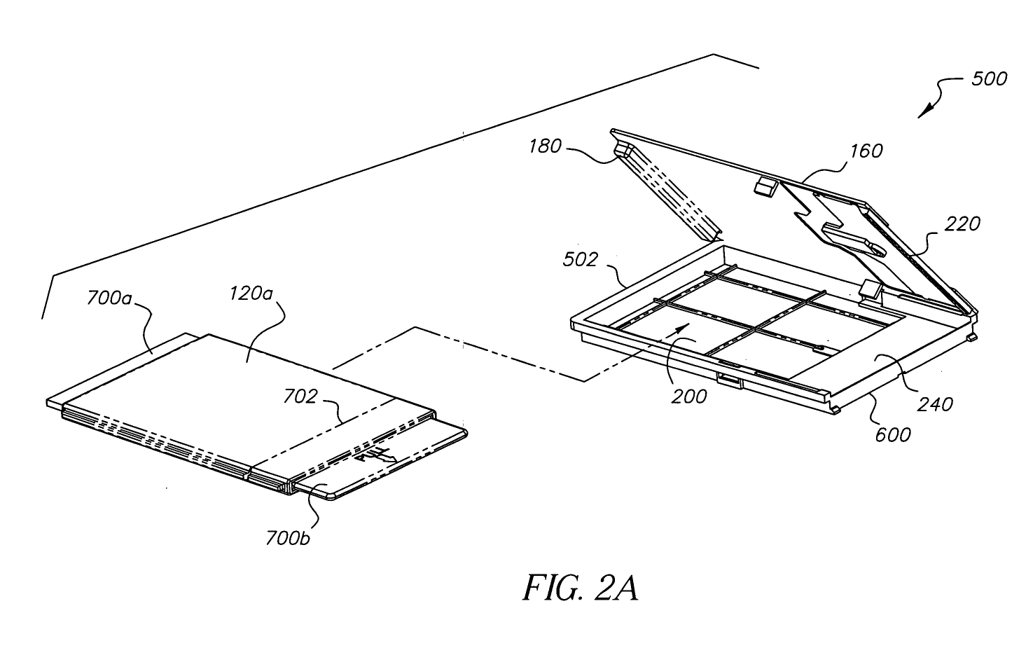

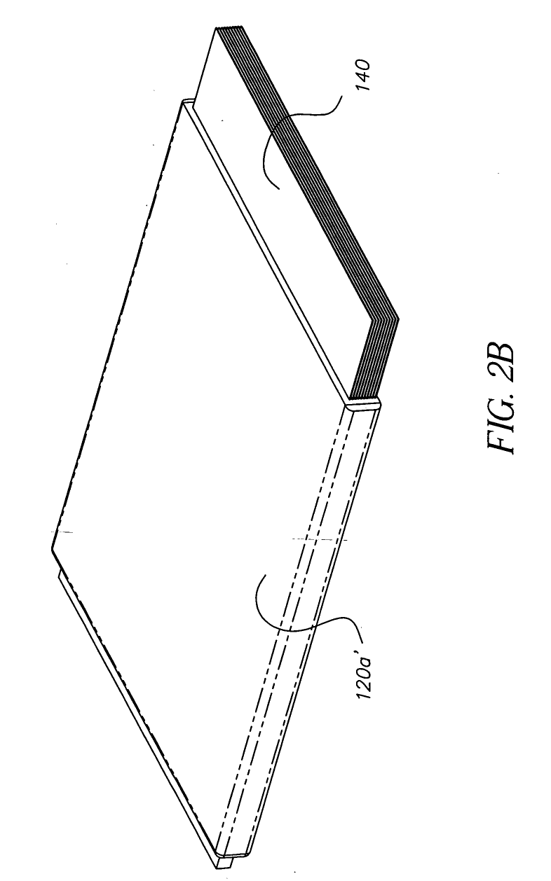

Referring now to FIG. 2A, the cartridge or cassette arrangement will now be described. FIG. 2A illustrates cassette arrangement 500 that is adapted to hold photosensitive media therein. The photosensitive media is preferable microencapsulated media for development and/or processing in image forming device 15 as described above. Cassette arrangement 500 comprises a cassette, cartridge or housing 502 that includes a holding area 200 that is sized to hold a media bag or pouch 120a. Media bag or pouch 120a is a light-tight, moisture proof pouch that is adapted to hold a stack 140 (FIG. 2B) of microencapsulated media therein. Bag or pouch 102a is light-tight so as to protect the media therein from accidental exposure to ambient light conditions. Further, pouch or bag 120a can be made of materials that are functional and low cost. Some non-limiting examples could be polypropylene with a polyethylene skin for heat sealing or a black paper with a glued in tear strip of aluminum.

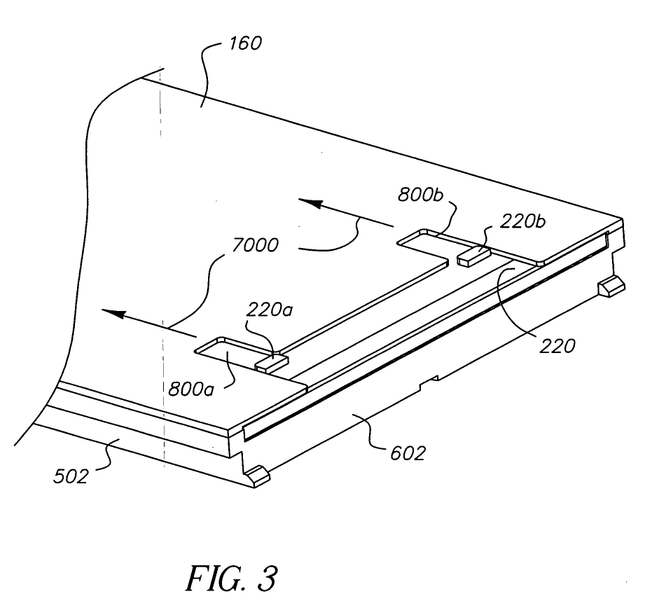

Housing 502 further includes a door 160 that is movable between an open position as shown in FIG. 2A and a closed position (FIG. 3) that provides a light-tight enclosure. Door 160 has a protruding or holding member 180 on one end of the door, and housing 502 has an interface end 600 that is adapted to interface with imaging device 15 as shown in FIG. 1A when the cassette arrangement 500 is inserted in imaging device 15.

As also shown in FIG. 2A, light-tight pouch 120a has a surface portion 700a on a first end and a sealed tab 700b on a second end. Sealed tab 700b includes a score or tear line 702 that enables a controlled tearing of sealed tab 700b when it is desired to open pouch 120 by removing tab 700b. As non-limiting examples, score or tear line 702 can be produced by laser scoring, blade scoring partial die cutting, full cut and resealing, the addition of a bonded tear strip or the use of oriented material. Sealed tab 700b is preferably heat-sealed or has a glued seam. The removal of tab 700b provides for an open pouch 120a′ as shown in FIG. 2B. With the arrangement of the present invention, sealed pouch 120a having a stack of media therein is placed in housing 502, and the door 160 is placed in the closed position. With door 160 closed and pouch 120a in housing 502, tab 700b would extend through or be exposed at interface end 600. This enables pouch 120a to be opened by removing tab 700b while pouch 120 is in closed cassette arrangement 500.

More specifically, holding area 200 is adapted to receive light tight, moisture proof pouch 120a therein, such that when door 160 is in the closed position as shown in FIG. 3, protruding member 180 of door 160 presses against surface portion 700a of pouch 120a, and sealed tab 700b of pouch 120a protrudes or extends through interface end 600 of housing 502. With this arrangement, protruding member 180 provides a holding force on pouch 120a by pressing on surface 700a to facilitate the tearing of tab 700b from outside of closed cassette arrangement 500. The tearing of tab 700b provides for a tear along score line 702 while pouch 120a is held within housing 502 by protruding member 180. The tearing of tab 700b provides for an opening of the pouch while the pouch is located in holding area 200 and door 160 is in the closed position. Reference numeral 120a′ of FIG. 2B illustrates the opened pouch as it would appear inside of housing 502. As an option, door 160 could be spring loaded to the closed position to help prevent an accidental opening of the door and enhance the holding force provided by member 180.

As shown in FIGS. 2A, 2B and 3, door 160 includes a sliding media door cover or portion 220 having two raised segments 220a and 220b (FIG. 3) FIG. 1A schematically shows raised segment 220a. Raised segments 220a and 220b are respectively designed to slide within slots 800a and 800b also provided on door 160. Interface end 600 of housing 502 further includes a closed wall or section 602 as shown in FIG. 3.

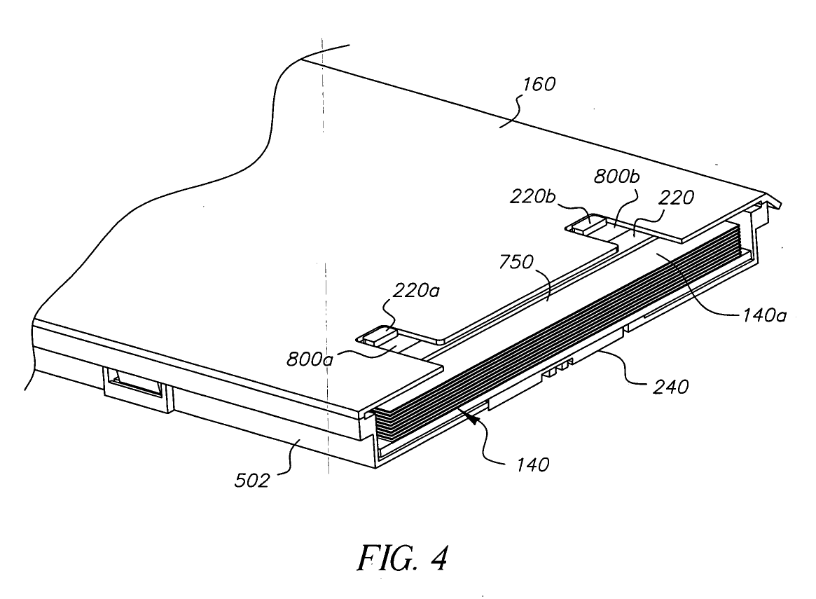

In the view of FIG. 4, closed wall section 602 is removed to facilitate the understanding of the invention. When loading a cassette arrangement 500 in accordance with the present invention into imaging device 15, a user places closed pouch 120a having a stack of photosensitive media therein into holding area 200 of housing 502. A user then closes door 160 to the position shown in FIGS. 3 and 4. The closing of door 160 causes protruding member 180 to press against surface 700a of pouch 120a and tab 700b to extend through an opening at interface end 600. The user than pulls tab 700b to cause a tear along score line 702 and an opening of pouch 120a. This assures that pouch 120a is opened while in a light-tight enclosure and further assures a consistent tearing of the pouch by providing for the score line as well as a capture of the pouch at surface 700b during the tearing operation. The user than inserts cassette arrangement 500 into imaging device 15. The imaging device is designed with cooperating members 3000 one of which is schematically shown in FIG. 1A which correspond to raised segments 220a, 220b. Cooperating members 3000 are designed to about against each raised segment 220a, 220b of media cover 220. More specifically, a sliding of cassette arrangement 500 into imaging device 15 causes cooperating members 3000 to abut against each of raised segments 220a and 220b to slide raised segments 220a, 220b in direction 7000 (FIG. 3) within slots 800a, 800b, from the position illustrated in FIG. 3 to the position illustrated in FIG. 4. This causes the sliding of media door cover or portion 220 from the closed position of FIG. 3 to the open position of FIG. 4, to provide for an opening or access location 750 at the top of cassette arrangement 500, and permit access to a topmost or top sheet 140a of media stack 140.

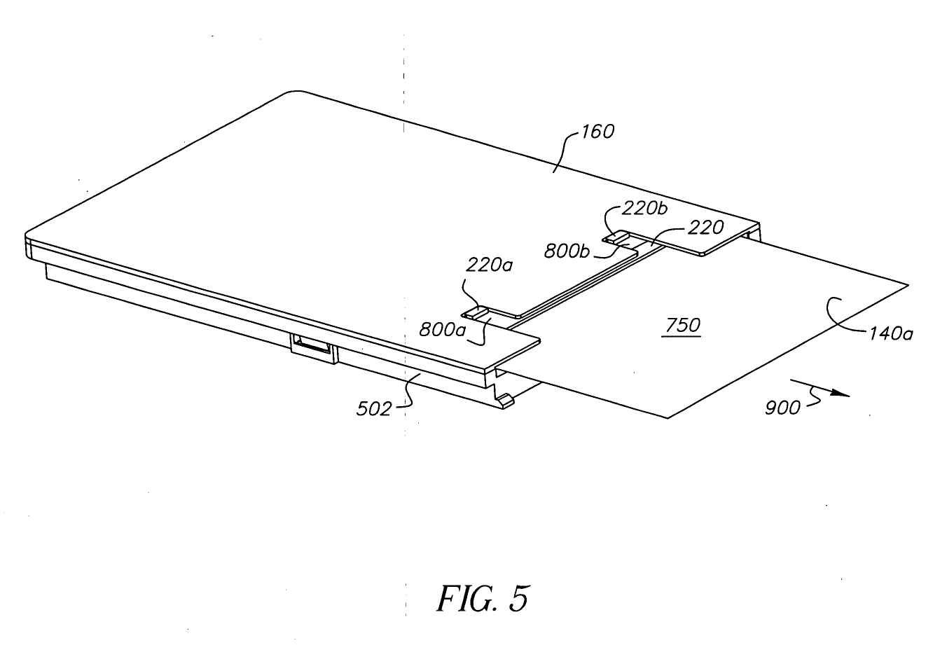

As shown in FIGS. 2A and 4, housing 502 also includes a media lift surface or mechanism 240 which is located in a vicinity of interface end 600 of housing 502 and provides an upward spring load force to urge the stack of media toward the top of the housing. Therefore, once cassette arrangement is inserted into image forming device 15 and the media door cover or portion 220 is slid open to expose the top most sheet 140a of the media stack, pick roller 21a in imaging device 15 will contact the top sheet of the stack and convey the sheet in a direction 900 as shown in FIG. 5. The media lift mechanism 240 provides a constant upward force to assure that the top sheet of the stack is always urged in an upward direction and against pick roller 21a to assure a consistent conveyance of one sheet at a time from the housing to the image-forming device. The sheet is then processed in the device in the manner as described above.

The present invention therefore provides for a cassette arrangement that includes a light-tight moisture proof pouch that is adapted to hold a stack of photosensitive sheets such as microencapsulated media, and load the sheets into an image-forming device in a light tight manner without damaging the sheets. The present invention further provides for an image-forming device which is adapted to interface with the cassette arrangement as well as a method of processing photosensitive sheets which utilizes the cassette arrangement.

The invention has been described in detail with particular reference to certain preferred embodiments thereof, but it will be understood that variations and modifications can be effected within the spirit and scope of the invention.

1. A cassette arrangement for photosensitive media, the cassette arrangement comprising:
a housing having a holding area and a door which is movable between an open position and a closed position, said door having a protruding member on one end of said door and said housing having an interface end which is adapted to interface with an imaging device when said cassette arrangement is inserted in the imaging device; and
a light tight pouch which is adapted to hold a stack of photosensitive media therein, said light-tight pouch having a surface portion on a first end and a sealed tab on a second end, said sealed tab including a score line to enable a controlled tearing of said sealed tab and an opening of said pouch;
said holding area being adapted to receive said light tight pouch therein such that when said door is in said closed position, said protruding member of said door presses against said surface portion of said pouch and said sealed tab of said pouch protrudes through said interface end of said housing to permit a tearing of said tab along said score line and an opening of said pouch when said pouch is located in said holding area and said door is in said closed position.

2. A cassette arrangement according to claim 1, wherein said photosensitive media is microencapsulated media.

3. A cassette arrangement according to claim 1, further comprising a slidable media cover located at a second end of said door which is opposite to said one end of the door, said media cover being slidable between a closed position which covers a top opening in said cassette arrangement when said cassette arrangement is removed from the imaging device, and an open position which opens said top opening when said cassette arrangement is inserted in said imaging device.

4. A cassette arrangement according to claim 3, wherein the open position of said slidable media cover when the cassette arrangement is inserted into the imaging device permits a portion of a pick roller of the imaging device to pass through said opening and convey a topmost media from said stack of media from said cassette arrangement to said imaging device.

5. A cassette arrangement according to claim 1, wherein said light-tight pouch is moisture proof.

6. A cassette arrangement according to claim 3, wherein said housing further comprises a spring loaded lifting surface on the interface end of said housing which is adapted to urge the stack of media toward the top opening in the door.

7. An image forming device comprising:
an imaging member adapted to form a latent image on photosensitive media;
a development member for developing the latent image; and
a cassette arrangement adapted to hold a stack of photosensitive media therein and interface with the image forming device to transfer the media from the cassette arrangement to the image forming device;
said cassette arrangement comprising:
a housing having a holding area and a door which is movable between an open position and a closed position, said door having a protruding member on one end of said door and said housing having an interface end which is adapted to interface with an imaging device when said cassette arrangement is inserted in the imaging device; and
a light tight pouch which is adapted to hold a stack of photosensitive media therein, said light-tight pouch having a surface portion on a first end and a sealed tab on a second end, said sealed tab including a score line to enable a controlled tearing of said sealed tab and an opening of said pouch;
said holding area being adapted to receive said light tight pouch therein such that when said door is in said closed position, said protruding member of said door presses against said surface portion of said pouch and said sealed tab of said pouch protrudes through said interface end of said housing to permit a tearing of said tab along said score line and an opening of said pouch when said pouch is located in said holding area and said door is in said closed position.

8. An image forming device according to claim 7, wherein said photosensitive media is microencapsulated media.

9. An image forming device according to claim 7, wherein said cartridge arrangement further comprising a slidable media cover located at a second end of said door which is opposite to said one end of the door, said media cover being slidable between a closed position which covers a top opening in said cassette arrangement when said cassette arrangement is removed from the imaging device, and an open position which opens said top opening when said cassette arrangement is inserted in said imaging device.

10. An image forming device according to claim 9, wherein the open position of said slidable media cover when the cassette arrangement is inserted into the imaging device permits a portion of a pick roller of the imaging device to pass through said opening and convey a topmost media from said stack of media from said cassette arrangement to said imaging device.

11. An image forming device according to claim 7, wherein said light-tight pouch is moisture proof.

12. An image forming device according to claim 9, wherein said housing further comprises a spring loaded lifting surface on the interface end of said housing which is adapted to urge the stack of media toward the top opening in the door.

13. A method of processing photosensitive media comprising the steps of:
using a light-tight pouch to store a stack of photosensitive media, said light-tight pouch having a surface portion at a first end and a sealed tab at a second end, wherein a tear line is provided in a vicinity of said sealed tab;
placing the pouch into a cassette arrangement having a door with a holding member and a slidable portion, such that a closing of said door causes said holding member of the door to press against said surface portion of said pouch and locates said sealed tab in a manner in which the sealed tab extends through an interface end of said cassette arrangement;
pulling said tab to cause a tearing of said pouch along said tear line and an opening of said pouch while said pouch is in said cassette arrangement;
inserting said cassette arrangement into an image forming device in a manner in which said slidable portion is opened to provide an access location for a topmost sheet of the stack of media;
using a pick roller to contact the topmost sheet of media through the access locating and convey the media into said image forming device; and
processing said media in said image forming device.

14. A method according to claim 13, wherein said media is microencapsulated media.

15. A cassette arrangement for photosensitive media, the cassette arrangement comprising:
a housing having a holding area and a door, said door having a protruding member on one end and said housing having an interface end which is adapted to interface with an image forming device when said cassette arrangement is inserted in the imaging device; and
a pouch which is adapted to hold photosensitive media therein, said pouch having a surface portion and a sealed tab, said sealed tab including a score line to enable a controlled tearing of said sealed tab and an opening of said pouch;
said holding area being adapted to receive said pouch therein such that when said door is closed, said protruding member of said door presses against said surface portion of said pouch and said sealed tab of said pouch protrudes through said interface end of said housing to permit a tearing of said tab along said score line and an opening of said pouch when said pouch is located in said holding area and said door is closed.
